(19) United States
(12) Patent Application Publication
(10) Pub. No.: US 2022/0033307 A1
(43) Pub. Date: Feb. 3, 2022

(54) SINTERED GEOPOLYMER COMPOSITIONS AND ARTICLES

(71) Applicant: Ahmed Redha Saleem Graytee, Elsternwick (AU)

(72) Inventor: Ahmed Redha Saleem Graytee, Elsternwick (AU)

(21) Appl. No.: 17/276,870

(22) PCT Filed: Sep. 23, 2019
(86) PCT No.: PCT/AU2019/051021

§ 371 Date: Mar. 17, 2021

(30) Foreign Application Priority Data
Sep. 21, 2018 (AU) 2018903545

(51) Int. Cl. C04B 28/00; B28B 11/24

(52) U.S. Cl. CPC C04B 28/006; C04B 2111/00431; B28B 11/24

(57) ABSTRACT

The present invention relates to geopolymer compositions, sintered geopolymer articles from the geopolymer compositions and processes for manufacturing sintered geopolymer articles from the geopolymer compositions. The invention provides a process of producing a sintered geopolymer article containing a sintered geopolymer composition, wherein the sintered geopolymer composition comprises a sintered geopolymeric matrix, said process comprising the steps of: (1) forming a geopolymer composition comprising at least one aluminosilicate precursor, an alkali activating agent and water, wherein in the geopolymer article, the aluminosilicate precursor particles are at least partially coated by the alkali activating agent; and (2) firing the geopolymer article to sinter the geopolymer composition, wherein the alkali activating agent is capable of at least partially activating and dissolving the aluminosilicate precursor particles during at least a portion of the firing step, and wherein the firing of the geopolymer article includes a geopolymer composition sintering stage.

### TECHNICAL FIELD OF THE INVENTION

The present invention relates to geopolymer composition, sintered geopolymer articles from the geopolymer composition and processes for manufacturing sintered geopolymer articles from the geopolymer compositions.

### BACKGROUND OF THE INVENTION

There is an increasing pressure on industrial sectors to find solutions to the environmental problems that are associated with their aluminosilicate industrial waste storage and management. Geopolymerisation process has gained increasing attention for its potential in recycling aluminosilicate industrial wastes as precursor materials. However, the current geopolymerisation process requires long curing time and uses concentrated alkali activating solutions. In addition, the geopolymerisation process is not effective when low water content or low alkali concentration is used in the composition according to the prior art. Furthermore, only limited amount of recycled aluminosilicates are effectively utilised by using the current geopolymerisation process.

On the other hand, the existing manufacturing processes of synthetic lightweight aggregate, ceramic proppant, brick, paver and tile industries require mining of countless tonnes of aluminosilicate-based materials (such as clay, shale, feldspar, bauxite and other materials) which often require further processing like sorting, grinding and sieving. In addition, these existing manufacturing processes require extensive energy and long firing time, and commonly require drying and preheating steps and slow heating/cooling rates to increase solidification and prevent cracking. Furthermore, the existing manufacturing processes cause large areas of land to be degraded and there is a considerable amount of waste associated with these industries.

It is important to develop a new process for producing aluminosilicate-based sintered articles that can effectively utilise aluminosilicate industrial wastes, use less energy, lower the cost and provide sintered articles having excellent properties which make such articles ideally suited as a substitute for conventional sintered article. The present invention aims at helping industrial sectors lower their production cost and lessen their environmental impact and encouraging recycling and beneficial uses of aluminosilicate industrial waste.

Sintered geopolymers may find application in the production of building and construction products such as aggregates, bricks, tiles, pavers, blocks, cladding and other building products. The process of the present invention can totally replace clay, shale and other natural aluminosilicate materials by recycled aluminosilicates in the above industries In addition, sintered geopolymer aggregates with appropriate properties may replace or offset the use of natural aggregates in concrete production, horticultural applications, green roofs, pipe bedding and trenches, for example. Furthermore, sintered geopolymer proppant may replace frac sand and ceramic proppant used in oil and gas industry.

The reference in this specification to any prior publication (or information derived from it), or to any matter which is known, is not, and should not be taken as, an acknowledgement or admission or any form of suggestion that prior publication (or information derived from it) or known matter forms part of the common general knowledge in the field of endeavour to which this specification relates.

### SUMMARY OF THE INVENTION

The present invention is directed to a process of manufacturing articles, such as aggregates, proppants, bricks, pavers, tiles and cladding using aluminosilicate materials. This process is significantly different from current processes of manufacturing aggregates, proppants, bricks, pavers, tiles and cladding such as geopolymerisation or sintering. The process of the present invention will vastly accelerate firing/sintering time, reduce energy consumption and boost production capacity. The process comprises an inventive sintering process which the inventor has developed and termed “alkali-activating sintering”. This sintering process is significantly different from the traditional liquid phase sintering process.

Without wishing to be bound by theory, the inventor believes that the formation of the alkali-activated sintering phase during firing of the geopolymer article comprises the following steps:

dissolution of the reactive materials from the surfaces of the aluminosilicate precursor particles through the action of the alkali activating agent;

formation of viscous and/or eutectic geopolymer gels on the surfaces of the aluminosilicate precursor particles;

flowing of the formed viscous and/or eutectic geopolymer gels to fill in the pore spaces between the aluminosilicate precursor particles; and

binding the aluminosilicate precursor particles together strongly by a geopolymeric matrix. An interfacial transition zone between the aluminosilicate precursor particles and the binding geopolymeric matrix may be formed which improves the bond between aluminosilicate precursor particles and the binding geopolymeric matrix. The interfacial transition zone may have a different chemical composition than the binding geopolymer matrix.

The inventor also believes that, the formation of the viscous geopolymer gels during alkali-activated sintering phase may initiate and/or promote and/or assist the conventional liquid-phase sintering which accelerate the sintering of the geopolymer composition. Furthermore, the inventor believes that, during firing/sintering, the mineralogical composition of the aluminosilicate precursor particles surfaces may change and become more reactive, and accordingly increase the dissolution of the aluminosilicate materials and improve geopolymerisation process. Yet further, the inventor believes that if the melting point of the alkali activating agent is reached before and/or during the sintering process, the alkali-activating sintering stage can be accelerated.

In an embodiment, the inventor has found that a firing/sintering time of less than two minutes is sufficient for sintering the geopolymer composition in the geopolymer article. In an embodiment, the inventor has found that the geopolymer article is capable of withstanding internal pressures of escaping gases and vapours, and resisting cracking or bursting during the firing step, when it is immediately subjected to a temperature of 1250° C. or higher, This capability holds even if the geopolymer article, at the time of firing, has a water content of greater than 30 wt % of the total weight of the geopolymer composition and an alkali activating agent content of less than 2 wt % of of the dry weight of the geopolymer composition. In an embodiment, the inventor has found that the sintered geopolymer article is capable of withstanding thermal differential stresses and resisting cracking when subjected to an aggressive cooling after the sintering process. Accordingly, a rapid heating and/or rapid cooling can be implemented in the current aluminosilicate-based manufacturing processes to optimise the production process by reducing firing time, total production cycle time, energy consumption and production cost.

In addition, the inventive alkali-activating sintering process can significantly reduce the alkali activating agent content in the geopolymer composition to less than 1 wt % of the dry weight of the geopolymer composition. Moreover, the inventive alkali-activating sintering process can significantly reduce the water content in the geopolymer composition to less than 1 wt % of the total weight of the geopolymer composition.

In an aspect, the present invention provides a process of producing a sintered geopolymer article having a matrix containing sintered geopolymer composition, said process comprising the steps of:

forming a geopolymer composition comprising at least one aluminosilicate precursor, an alkali activating agent and water, wherein in the geopolymer article, the aluminosilicate precursor particles are at least partially coated by the alkali activating agent; and

firing the geopolymer article to sinter the geopolymer composition, wherein the alkali activating agent is capable of at least partially activating and dissolving the aluminosilicate precursor particles during at least a portion of the sintering phase of the geopolymer composition and wherein the sintering phase of the geopolymer composition includes an alkali-activated sintering stage.

Preferably the geopolymer composition substantially only comprises aluminosilicate precursor, an alkali activating agent and water.

Preferably the aluminosilicate precursor content in the geopolymer composition is from 80 to 98 wt % of the dry weight of the geopolymer composition.

Preferably the alkali activating agent content in the geopolymer composition is from 0.1 to 12 wt % of the dry weight of the geopolymer composition.

Preferably the alkali activating agent content in the geopolymer composition is less than 12 wt % of the dry weight of the geopolymer composition.

Preferably the alkali activating agent content in the geopolymer composition is less than 10 wt % of the dry weight of the geopolymer composition.

Preferably the alkali activating agent content in the geopolymer composition is less than 6 wt % of the dry weight of the geopolymer composition.

Preferably the alkali activating agent content in the geopolymer composition is less than 1 wt % of the dry weight of the geopolymer composition.

Preferably the water content in the geopolymer composition is less than 30 wt % of the total weight of the geopolymer composition.

Preferably the water content in the geopolymer composition is less than 20 wt % of the total weight of the geopolymer composition.

Preferably the water content in the geopolymer composition is less than 10 wt % of the total weight of the geopolymer composition.

Preferably the water content in the geopolymer composition is less than 6 wt % of the total weight of the geopolymer composition.

Preferably the water content in the geopolymer composition is less than 1 wt % of the total weight of the geopolymer composition.

Preferably the aluminosilicate precursor is fly ash, blast furnace slag, ground granulated blast furnace slag metakaolin, aluminum silicate, silica fume, silico-manganese slag, fluid catalytic cracking catalyst residue, coal bottom ash, rice husk ash, palm oil fuel ash, peat-wood ash, waste glass, ceramic wastes, chamotte, waste bricks, paper sludge ash, calcined sludge, municipal solid waste incineration ash, calcined clays, grog, calcined bauxite, recycled construction and demolition waste, mine tailings, mineral processing tailings such as coal gangue, red mud, aluminum silicate, aluminum phyllosilicate, clay, shale, slate, feldspars (like soda feldspar and potash feldspar), perlite, alumina, bauxite, kaolin, bentonite, kaolinite, basalt, laterite, volcanic ash, zeolitic tuff, mullite, albite, pyrophyllite, spodumene, beryl, nepheline syenite, almandine, grossular, sillimanite, andalusite, kyanite, pumpellyite, spodumene, augite, lepidolite, illite, celsian, sodalite, stilbite, heulandite, anorthite or mixtures thereof.

Preferably the aluminosilicate precursor is capable of acting as a binding agent and/or a fluxing agent and/or blowing agent.

Preferably the alkali activating agent is sodium hydroxide, potassium hydroxide, lithium hydroxide, rubidium hydroxide, caesium hydroxide, ammonium hydroxide, sodium silicate, sodium metasilicate, potassium silicate, potassium metasilicate, lithium silicate, sodium carbonate, potassium carbonate, calcium carbonate, sodium sulfate, potassium sulfate, sodium aluminate, borax or mixtures thereof.

Preferably the alkali activating agent is capable of binding the geopolymer composition particles in the geopolymer article, and wherein the modulus of rupture of the green article is greater than 0.1 MPa.

Preferably the alkali activating agent is capable of acting as an alkali activating agent and/or a binding agent and/or a fluxing agent and/or blowing agent and/or a foaming agent.

Preferably, the melting point of the alkali activating agent is at a temperature of between 800° C. and 1500° C.

Preferably the geopolymer composition may further comprise one or more additive in a total amount of from 0.1 to 10 wt % of the dry weight of the geopolymer composition.

Preferably the additive is filler, catalyst, binding agent (such as inorganic and organic binders used in ceramic industries to improve the green strength of the geopolymer article), colouring agent (such as colour oxides, pigments and dyes), water reducing agent (such as plasticisers and superplasticisers), setting agent, lubricant, surfactant, reinforcing agent (such as fibers), fire-resistant agent, firing/sintering shrinkage reducing agent, foaming agent (such as sodium perborate, aluminium oxide and hydrogen peroxide), blowing agent (such as calcium borate, sodium borate) fluxing agent (such as iron oxide cullet powder (amorphous SiO₂), silica fume and quartz powder, metallic Fe powder and cement dust), fuel source such as coal dust and saw dust or mixtures thereof.

Preferably the average particle size of dry components of the geopolymer composition is in the range of 1 μm to 1000 μm.

Preferably the average particle size of the dry components of the geopolymer composition is less than 100 μm.

Preferably the average particle size of the dry components of the geopolymer composition is less than 50 μm.

Preferably the average particle size of the dry components of the geopolymer composition is less than 10 μm.

Preferably the average particle size of the dry components of the geopolymer composition is less than 1 μm.

Preferably the geopolymer article is formed from the geopolymer composition using pressure or non-pressure forming technique.

Preferably all aluminosilicate precursor particles are coated by the alkali activating agent in the geopolymer composition of the formed geopolymer article.

Preferably non-pressure forming process is performed by an apparatus selected from high shear mixer, pin mixer, paddle mixer, disc pelletiser, agglomerator, agglomerator drum, rotary drum agglomerator, agglomeration drum, drum agglomerator, drum pelletiser, rotary agglomerator, heap leaching drum, rotary drum, balling drum, granulator, granulator drum, granulation drum, drum granulator, rotary granulator, vibrating table, shaking table or any combination thereof.

Preferably pressure forming process is performed by an apparatus selected form vibro compacting apparatus, extrusion press, pellet mill, roll press, punch and die press, briquetting roll press, tablet press or any combination thereof.

Preferably the geopolymer composition is subjected to a pressure of from 1 MPa to 80 MPa during pressure forming process.

Preferably the geopolymer article is fired without any curing and/or preheating of the geopolymer article.

Preferably sintering is performed by conventional sintering, microwave sintering or microwave hybrid sintering.

Preferably firing is performed by an apparatus selected from conveyor furnace, strand sintering furnace, roller kiln, roller hearth kiln, shuttle kiln, tunnel kiln, rotary kiln, microwave sintering furnace, microwave hybrid sintering furnace, microwave assisted sintering furnace and microwave rotary kiln.

Preferably firing is performed as a continuous process.

Preferably firing process may comprise a preheating stage in which the geopolymer composition is subjected to heat treatment at temperatures of between 150° C. to 800° C.

Preferably firing process may comprise a calcination stage in which the geopolymer composition is subjected to heat treatment at temperatures of between 300° C. to 800° C.

Preferably the geopolymer composition in the geopolymer article is subjected to a sintering temperature of from 800° C. to 1500° C. during at least a portion of the firing step.

Preferably the geopolymer composition in the geopolymer article is sintered at a temperature of from 1000° C. to 1300° C. during at least a portion of the firing step.

Preferably the geopolymer article is immediately subjected to a sintering temperature of from 800° C. to 1500° C. during the firing step.

Preferably the geopolymer article is heated to the sintering temperature at a rate greater than or equal to 600° C./minute during at least a portion of the firing step.

Preferably the geopolymer article is heated to the sintering temperature at a rate greater than or equal to 200° C./minute during at least a portion of the firing step.

Preferably the geopolymer article is heated to the sintering temperature at a rate greater than or equal to 100° C./minute during at least a portion of the firing step.

Preferably the geopolymer article is heated to the sintering temperature at a rate greater than or equal to 50° C./minute during at least a portion of the firing step.

Preferably the geopolymer article is heated to the sintering temperature at a rate greater than or equal to 10° C./minute during at least a portion of the firing step.

Preferably the duration of sintering stage is less than or equal to 120 minutes.

Preferably the duration of sintering stage is less than or equal to 60 minutes.

Preferably the duration of sintering stage is less than or equal to 30 minutes.

Preferably the duration of sintering stage is less than or equal to 15 minutes.

Preferably the duration of sintering stage is less than or equal to 5 minutes.

Preferably the duration of sintering stage is less than or equal to 1 minute.

Preferably after sintering, the geopolymer article is cooled at a rate greater than or equal to 600° C./minute during at least a portion of the cooling step.

Preferably after sintering, the geopolymer article is cooled at a rate greater than or equal to 200° C./minute during at least a portion of the cooling step.

Preferably after sintering, the geopolymer article is cooled at a rate greater than or equal to 100° C./minute during at least a portion of the cooling step.

Preferably after sintering, the geopolymer article is cooled at a rate greater than or equal to 50° C./minute during at least a portion of the cooling step.

Preferably after sintering, the geopolymer article is cooled at a rate greater than or equal to 10° C./minute during at least a portion of the cooling step.

Preferably the sintered geopolymer article is a sintered geopolymer aggregate, proppant, brick, paver, wall tile, floor tile, roof tile, benchtop, floating article, cladding, sheeting, precast unit or building element.

In an aspect, the present invention provides a process of producing sintered geopolymer aggregates. Preferably the sintered geopolymer aggregate is of a predetermined particle size range. More preferably the predetermined particle size range covers sintered geopolymer aggregate particles size of from 75 μm to 30 mm.

In an aspect, the present invention provides a process of producing sintered geopolymer aggregates comprising crushing of sintered geopolymer articles to provide crushed sintered geopolymer aggregates. Preferably the process comprises screening and sizing the sintered geopolymer aggregate particles to a predetermined particle size range. Generally, the predetermined particle size range covers sintered geopolymer aggregate particles size of from 75 μm to 30 mm.

In an aspect the present invention provides the use of sintered geopolymer aggregates produced according to the invention in the manufacture of structural lightweight concrete, high strength lightweight concrete, floating concrete, lightweight geopolymer concrete, lightweight roof tiles, lightweight cladding, lightweight precast units, structural fill, floor and roof screed, drainage and filler media and refractory uses.

In an aspect the present invention provides a concrete formed with sintered geopolymer aggregates produced according to the process provided by the present invention.

In an aspect the present invention provides a process of producing sintered geopolymer proppants. Preferably the sintered geopolymer proppants is of a predetermined particle size range. More preferably the predetermined particle size range covers sintered geopolymer proppant particles size of from 106 μm to 2.36 mm.

In an aspect the present invention provides a process of producing sintered geopolymer bricks.

In an aspect the present invention provides a process of producing sintered geopolymer tiles. Preferably the thickness of the sintered geopolymer tile is less than 40 mm.

### DETAILED DESCRIPTION OF THE PREFERRED EMBODIMENTS

The following modes, given by way of example only, are described to provide a more precise understanding of the subject matter of a preferred embodiment or embodiments.

Described herein is a geopolymer composition, sintered geopolymer articles manufactured from the geopolymer composition such as aggregates, proppants, bricks, pavers, tiles and methods for the manufacturing of sintered geopolymer articles.

In an embodiment, the geopolymer composition may comprise aluminosilicate precursor, an alkali activating agent and water, wherein in the geopolymer composition, the aluminosilicate precursor particles are at least partially coated by the alkali activating agent, and wherein the alkali activating agent content in the geopolymer composition is from 0.1 to 12 wt % of the dry weight of the geopolymer composition, and wherein the water content in the geopolymer composition is less than 30 wt % of the total weight of the geopolymer composition.

In an embodiment, the geopolymer composition may be made from a single geopolymer composition, multiple different geopolymer compositions or a combination of geopolymer compositions and non-geopolymer compositions. These compositions may be added separately to the geopolymer composition at the same stage or at different stages of the process. Accordingly, in the context of the specification, the term “geopolymer composition” includes within its scope these different alternatives and the term is not limited to a single composition.

In an embodiment, the alkali activating agent may be included in the geopolymer composition in any suitable concentration and any suitable form. Alkali activating agents are available in both solid and liquid form, and in varying concentrations. The alkali activating agent may be made from a single component or it may be made from multiple components. These components may be premixed, or they may be added separately to the geopolymer composition at the same stage or at different stages of the process. Accordingly, in the context of the specification, the term “alkali activating agent” includes within its scope these different alternatives and it is not limited to a single component. The alkali activating agent may be used in a solid form, powder form, liquid form and mixtures thereof. Alkali activating agents of various silica to alkali ratios (i.e. SiO₂/M₂O, where M is alkali metal), alkali metals, concentrations, densities, viscosities, melting points and mixtures thereof may be used in the geopolymer composition. In a preferred embodiment, the alkali activating agent in the geopolymer composition may comprise a mixture of various alkali activating agent components and of various alkali activating agent component ratios to adjust the alkali activating and binding and/or fluxing and/or blowing and/or foaming capabilities of the alkali activating agent in the geopolymer composition in order to optimise the manufacturing process variables and techniques and the properties of the sintered geopolymer articles.

In a preferred embodiment, the melting point of the alkali activating agent is at a temperature of between 800° C. and 1500° C.

It will be understood that all references to amount/content of the alkali activating agent refer to the total amount/content of solids in the alkali activating agent only and excludes any water that may be present in the alkali activating agent. For example, a 3.22 ratio liquid sodium silicate of 1.38 g/cc made by PQ Australia contains 8.7-9.1 wt % of Na₂O, 28.4-28.9 wt % of SiO₂ with a total solids content of 37.1-38.0 wt % and water content of 62-62.9 wt % of the total weight of the sodium silicate solution. Another example, a sodium metasilicate anhydrous in a granular powder solid form and commercially available from Redox Pty Ltd contains 50-52 wt % of Na₂O, 45-47 wt % of SiO₂ with a total solids content of 95-99 wt % and water content of 1-5 wt % of the total weight of the sodium metasilicate anhydrous granular powder.

Any alkali activating agent capable of at least partially activating and dissolving the aluminosilicate precursor particles during firing/sintering process may be used in the invention. In an embodiment, the alkali activating agent may be alkali hydroxides, alkali silicates, alkali carbonates, alkali sulfates or mixtures thereof. In an embodiment, the alkali component may be sodium hydroxide, potassium hydroxide, lithium hydroxide, rubidium hydroxide, caesium hydroxide, ammonium hydroxide, sodium silicate, sodium metasilicate, potassium silicate, potassium metasilicate, lithium silicate, sodium carbonate, potassium carbonate, calcium carbonate, sodium sulfate, potassium sulfate, sodium aluminate, borax or mixtures thereof.

In an embodiment, the inventor has found that aluminosilicate precursor properties, forming process variables and techniques, firing process variables and techniques and desired physical and mechanical properties of the manufactured sintered geopolymer articles (such as strength, density, porosity and absorption capacity) have a significant impact on the amount of alkali activating agent required by the geopolymer composition.

The properties of the aluminosilicate precursor used in the geopolymer composition, such as particle size, particle size distribution, particle shapes, porosity, surface texture and the mineralogical composition and the reactivity of the materials on the aluminosilicate precursor particles surface may have a significant impact on the amount of alkali activating agent required by the geopolymer composition.

A geopolymer composition comprised of fine graded/classified fly ash as aluminosilicate precursor may generally lead to a sintered geopolymer article of higher strength compared with a sintered geopolymer article formed from a composition comprising ungraded/unclassified fly ash. Accordingly, a lesser amount of alkali activating agent may be required to manufacture a sintered geopolymer article of same strength as a sintered geopolymer article formed from a composition comprising ungraded/unclassified fly ash.

The forming technique used in manufacturing sintered geopolymer articles may also affect the amount of alkali activating agent required by the geopolymer composition. Generally, geopolymer composition formed by pressure forming technique lead to sintered geopolymer articles with enhanced physical and mechanical properties compared to those formed by non-pressure forming technique. Accordingly, a lesser amount of alkali activating agent may be required to manufacture a sintered geopolymer article using pressure forming technique that features the same strength as a sintered geopolymer article formed using non-pressure forming technique.

The firing process variables may also influence the amount of alkali activating agent required by the geopolymer composition. Increasing the amount of alkali activating agent in the geopolymer composition may reduce the sintering time required to produce a sintered geopolymer article with a good strength compared to a sintered geopolymer article formed with a lesser amount of alkali activating agent. Furthermore, increasing the sintering temperature may lower the amount of alkali activating agent required to produce a sintered geopolymer article with good strength compared to a sintered geopolymer article manufactured at a lower sintering temperature.

In an embodiment, the alkali activating agent content in the geopolymer composition is from 0.1 to 12 wt % of the dry weight of the geopolymer composition

In an embodiment, the alkali activating agent content in the geopolymer composition is less than 12 wt % of the dry weight of the geopolymer composition.

In an embodiment, the alkali activating agent content in the geopolymer composition is less than 10 wt % of the dry weight of the geopolymer composition.

In an embodiment, the alkali activating agent content in the geopolymer composition is less than 6 wt % of the dry weight of the geopolymer composition.

In an embodiment, the alkali activating agent content in the geopolymer composition is less than 1 wt % of the dry weight of the geopolymer composition.

In an embodiment, the water component of the geopolymer composition is provided as part of the alkali activating agent (i.e. water content of the alkali activating agent) and no additional water is added to the geopolymer composition. In an embodiment, the water component of the geopolymer composition may be added to the geopolymer composition in a solution with the alkali activating agent termed “alkali activating solution”. In an embodiment, some or all of the water component may be added to the geopolymer composition independently of the alkali activating agent.

In an embodiment, the inventor has found that aluminosilicate precursor properties, forming process variables and techniques, firing process variables and techniques and desired physical and mechanical properties of the manufactured sintered geopolymer articles (such as strength, density, porosity and absorption capacity) have a significant impact on the amount of water required by the geopolymer composition. The properties of the aluminosilicate precursor used in the geopolymer composition, such as particle size, particle size distribution, particle shapes, porosity and surface texture may have a significant impact on the amount of water required by the geopolymer composition.

In an embodiment, the water content in the geopolymer composition is less than 30 wt % of the total weight of the geopolymer composition.

In an embodiment, the water content in the geopolymer composition is less than 20 wt % of the total weight of the geopolymer composition.

In an embodiment, the water content in the geopolymer composition is less than 10 wt % of the total weight of the geopolymer composition.

In an embodiment, the water content in the geopolymer composition is less than 6 wt % of the total weight of the geopolymer composition.

In an embodiment, the water content in the geopolymer composition is less than 1 wt % of the total weight of the geopolymer composition.

In an embodiment, the aluminosilicate precursor in the geopolymer composition may be made from a single aluminosilicate precursor component or may be made from multiple aluminosilicate precursor components. These components may be premixed or may be added separately to the geopolymer composition at the same stage or at different stages of the process. Accordingly, in the context of the specification, the term “aluminosilicate precursor” includes within its scope these different alternatives and not limited to a single component. Any aluminosilicate precursor may be used in the invention. Suitable aluminosilicate precursors to be added to the geopolymer composition may include natural aluminosilicates, industrial products, industrial by-products and industrial wastes. Examples of suitable aluminosilicate precursors include, but are not limited to, fly ash, blast furnace slag, ground granulated blast furnace slag metakaolin, aluminum silicate, silica fume, silico-manganese slag, fluid catalytic cracking catalyst residue, coal bottom ash, rice husk ash, palm oil fuel ash, peat-wood ash, waste glass, ceramic wastes, chamotte, waste bricks, paper sludge ash, calcined sludge, municipal solid waste incineration ash, calcined clays, grog, calcined bauxite, recycled construction and demolition waste, mine tailings, mineral processing tailings such as coal gangue, red mud, aluminum silicate, aluminum phyllosilicate, clay, shale, slate, feldspars (like soda feldspar and potash feldspar), perlite, alumina, bauxite, kaolin, bentonite, kaolinite, basalt, laterite, volcanic ash, zeolitic tuff, mullite, albite, pyrophyllite, spodumene, beryl, nepheline syenite, almandine, grossular, sillimanite, andalusite, kyanite, pumpellyite, spodumene, augite, lepidolite, illite, celsian, sodalite, stilbite, heulandite and anorthite.

In an embodiment, the aluminosilicate precursor is fly ash. Fly ashes of various physical properties and chemical compositions may be used. Fly ash used may be class F or class C or a combination of Class F and Class C. Furthermore, the fly ash used may be ultrafine graded/classified, fine graded/classified or ungraded/unclassified fly ash (i.e. run of station fly ash) or any combination thereof. In some embodiments, the fly ash may comprise a mixture of different grades of fly ash and/or fly ashes from different sources.

The specific properties of the aluminosilicate precursor may affect the relative amounts of the other components comprising the geopolymer composition. The specific properties of the aluminosilicate precursor may also affect the forming and firing techniques used, as well as the sintering temperature and sintering time and other process variables. In some embodiments, fine graded/classified fly ash may be used to manufacture high quality sintered geopolymer articles, whereas using ungraded/unclassified fly ash may be advantageous in that, it may be available directly from a power station which reduce the production cost of the sintered geopolymer articles. In some embodiments, the fly ash may comprise a mixture of different grades of fly ash and/or fly ashes from different sources. In a preferred embodiment, the aluminosilicate precursor comprise a mixture of various aluminosilicate precursor components and of various aluminosilicate precursor components ratios to adjust the physical and chemical properties of the geopolymer composition such as average particle size, particle size distribution, surface area, SiO₂ content, Al₂O₃ content, Fe₂O₃ content, CaO content other mineral content, silicon to aluminum oxide mole ratio, Si/Al ratio, glassy phase content and LOI (Los on Ignition) content to produce geopolymer composition with the desired properties to optimize the manufacturing process variables and techniques and the properties of the sintered geopolymer articles.

The particle size distribution of the aluminosilicate precursor may affect the particle packing density during forming of the geopolymer article. An optimum particle packing with the total interstitial spaces between aluminosilicate precursor particles minimised may produce a high density geopolymer article which may lead to improved properties. High packing densities may be achieved if the aluminosilicate precursor has a wide particle size distribution, wherein a sufficient amount of smaller particles exist to occupy the interstitial space between larger particles. Aluminosilicate precursor with larger amounts of fine particles may also reduce the amount of water required by the geopolymer composition, and may also exhibit a higher surface area, leading to higher aluminosilicate precursor surface reactivity which may in turn accelerate the alkali-activating sintering phase and reduce the firing/sintering time required to produce the sintered geopolymer articles with the desired characteristics in terms of strength, density, porosity, absorption capacity and other properties.

In an embodiment, the aluminosilicate precursor is milled to reduce the particle size. One benefit of milling the aluminosilicate precursor is to increase the reactivity of the aluminosilicate precursor by increasing the surface area available for alkaline activation. In some embodiments, the alkaline activator agent is mixed and milled with the aluminosilicate precursor to assist the homogeneity of the geopolymer composition. In some embodiments, the geopolymer composition including at least one alkali activator agent and possibly other additives are mixed and milled to assist the homogeneity of the geopolymer composition.

In an embodiment, the average particle size of dry components of the geopolymer composition is less than 1 μm (micron). In an embodiment, the average particle size of dry components of the geopolymer composition is less than 10 μm. In some embodiments, the average particle size of dry components of the geopolymer composition is less than 50 μm. In some embodiments, the average particle size of dry components of the geopolymer composition is less than 150 μm. In some embodiments, the average particle size of dry components of the geopolymer composition is less than 300 μm. In some embodiments, the average particle size of dry components of the geopolymer composition is less than 1000 μm. Preferably, the average particle size of dry components of the geopolymer composition is in the range of from 1 μm to 10 μm.

In an embodiment, the aluminosilicate precursor content in the geopolymer composition is from 80 to 99 wt % of the dry weight of the geopolymer composition.

In an embodiment, the aluminosilicate precursor content in the geopolymer composition is greater than 80 wt % of the dry weight of the geopolymer composition.

In an embodiment, the geopolymer composition may further comprise one or more additive in any form or any combination and in a total amount of from 0.1 to 10 wt % of the dry weight of the geopolymer composition. These additives may be premixed or may be added separately to the geopolymer composition at the same stage or at different stages of the process. Any additive that could be beneficial to the manufacturing process steps and/or the use of the sintered geopolymer articles resulting from the geopolymer composition can be included. Non-limiting examples of additives useful in the present invention which may be added to the geopolymer composition include, fillers, catalysts, binding agents (such as inorganic and organic binders used in ceramic industries to improve the green strength of the geopolymer article), colouring agents (such as colour oxides, pigments and dyes), water reducing agents (such as plasticisers and superplasticisers), setting agents, lubricants, surfactants, reinforcing agents (such as fibers), fire-resistant agents, firing/sintering shrinkage reducing agents, foaming agents (such as sodium perborate, aluminium oxide and hydrogen peroxide), blowing agents (such as calcium borate, sodium borate) fluxing agents (such as iron oxide cullet powder (amorphous SiO₂), silica fume and quartz powder, metallic Fe powder and cement dust) and fuel sources such as coal dust and saw dust.

In an embodiment, the alkali activating agent comprises component/components capable of playing different roles in the geopolymer composition during the same step or different steps of the manufacturing process. For example, sodium hydroxide may be used to act as both alkali activating and fluxing agent during the firing process. Another example, calcium carbonate may be used to act as both alkali activating and foaming agent during the firing process. Another example, sodium silicate may be used to act as a binding agent during the forming process and as an alkali activating agent during the firing process. In a preferred embodiment, the alkali activating agent in the geopolymer composition may comprise a mixture of various alkali activating agent components and of various alkali activating agent components ratios to adjust the alkali activating and/or binding and/or fluxing and/or blowing and/or foaming capabilities of the alkali activating agent in the geopolymer composition to optimize the manufacturing process variables and techniques and the properties of the sintered geopolymer articles. In embodiment, the alkali activating agent is capable of binding the geopolymer composition particles in the geopolymer article, and wherein the modulus of rupture of the green article is greater than 0.1 MPa.

In an embodiment, the aluminosilicate precursor comprises component/components capable of playing different roles in the geopolymer composition during the same step or different steps of the manufacturing process. For example, aluminum silicate and bentonite may be used to act as binding agents during the forming process and as aluminosilicate source materials necessary for geopolymerisation process during firing process. In a preferred embodiment, the aluminosilicate precursor in the geopolymer composition may comprise a mixture of various aluminosilicate precursor components and of various aluminosilicate precursor components ratios to adjust the binding and/or fluxing and/or blowing capabilities of the aluminosilicate precursor in the geopolymer composition to optimize the manufacturing process variables and techniques and the properties of the sintered geopolymer articles.

### Manufacturing Steps

Described herein is an example embodiment of a process to manufacture sintered geopolymer articles. Manufacturing process comprises many steps and certain steps may be optional. Whether or not the process employs these steps may be determined by the properties and proportions of the geopolymer composition components, the forming process variables and techniques used, the firing technique used, the desired properties of the sintered geopolymer article as well as other variables. Multiple process steps may be combined and performed in one apparatus, for example, milling and mixing steps may be performed in a milling apparatus. Another example, mixing and forming steps may be performed in one agglomeration/granulation apparatus such as a high shear mixer or an extrusion press.

In an embodiment, aluminosilicate precursor components, alkali activating agent components and other additive components may be subjected to a milling process step (i.e. particle size reducing step) where these components may be milled separately or together in any combination at the same time or at different times or stages of the process step.

In an embodiment, aluminosilicate precursor components, alkali activating agent components, water and other additive components may be subjected to a mixing process step, where these components may be mixed in any combination at the same time or at a different times or stages of the process step.

In an embodiment, the milled and/or mixed geopolymer composition components may be subjected to a screening process step, to ensure that the required particle size and/or the required particle size distribution is present in the geopolymer composition to improve particle packing density of the geopolymer composition during the formation of the geopolymer article.

In an embodiment, the aluminosilicate precursor is subjected to a mechanical activation process step in which the aluminosilicate precursor is milled to reduce the particle size, increase the surface area and change the morphology and mineralogical composition of the particles to increase the reactivity of the aluminosilicate precursor particles, and accordingly increase the dissolution of the aluminosilicate materials and improve the geopolymerisation process during firing process step.

The geopolymer composition may then undergo a forming process step to form the geopolymer composition article. In an embodiment, the geopolymer composition may be formed by using pressure forming techniques or non-pressure forming techniques or any combination thereof. Preferably, in some non-pressure forming techniques, two different agglomeration/granulation apparatuses are used to perform the forming step, wherein the aluminosilicate precursor and at least a portion of the alkali activating solution may be used in the first agglomeration/granulation apparatus to condition and wet the aluminosilicate precursor in order to improve the efficiency and productivity of the subsequent forming step. The first agglomeration/granulation apparatus may be of any suitable type, including a high shear mixer, a pin mixer, a paddle mixer or otherwise. After this conditioning step, the remaining portion of the alkali activating solution may be sprayed onto the conditioned composition in the second agglomeration/granulation apparatus such as a disc pelletiser or a rotary drum to complete the forming step.

In an embodiment, the forming process step may be performed as a continuous process. In an embodiment, the forming process may be performed as a staged process. In an embodiment, the forming process may produce a geopolymer article comprising a core and one or more coating layer having a composition different from that of the of the core. In an embodiment, the forming process may produce a geopolymer article comprising multiple layers of different compositions. In a preferred embodiment, the forming apparatus/apparatuses variables and techniques are adjusted such that the geopolymer article produced by the forming process are of the desired size and/or dimensions, shape, roundness, core size, coating layer thickness and layer thickness.

In an embodiment, the forming step may be performed by a non-pressure agglomeration/granulation apparatus of any suitable type, including a high shear mixer, a pin mixer, a paddle mixer, a disc pelletiser, agglomerator, an agglomerator drum, a rotary drum agglomerator, an agglomeration drum, a drum agglomerator, a drum pelletiser, a rotary agglomerator, a heap leaching drum, a rotary drum, a balling drum, a granulator, a granulator drum, a granulation drum, a drum granulator, a rotary granulator, a vibrating table, a shaking table or any combination thereof. In an embodiment, the geopolymer composition may be casted into a mould then subjected to a vibration by any suitable vibrating apparatus. In an embodiment, the geopolymer composition is highly flowable and may be poured into a mould without the need for vibration.

In an embodiment, the forming step may be performed by a pressure agglomeration/granulation apparatus of any suitable type, including a vibro compacting apparatus, an extrusion press, a pellet mill, a roll press, a punch and die press, a briquetting roll press, a tablet press or any combination thereof. The geopolymer composition may be subjected to a pressure in the range of from 1 MPa to 80 MPa during the pressure forming step.

The selection of the type of the forming apparatus and/or the amount of pressure applied may depend on the properties of the geopolymer composition and the desired size and shape and the required technical properties of the sintered geopolymer articles.

The type of forming process selected to manufacture the sintered geopolymer articles may also be affected by the properties of the aluminosilicate precursor used in the geopolymer composition. For instance, the water demand of the aluminosilicate precursor, as well as the desired properties of the manufactured sintered geopolymer articles may inform the selection of the forming technique. For example, fine grade fly ash may require a relatively low amount of water to be added to the geopolymer composition, making geopolymer composition formed from this fly ash suitable for any type of forming technique such as plastic forming (also called wet forming), semi dry pressing/compaction and dry pressing/compaction processes. Conversely, use of ungraded/unclassified fly ash may require the addition of a relatively large amount of water to the geopolymer composition which is not preferable, making geopolymer composition formed from this fly ash suitable for use with semi dry pressing/compaction and dry pressing/compaction processes which usually require lower amounts of water in the geopolymer composition. Furthermore, semi dry pressing/compaction and dry pressing/compaction processes may be suitable for use with geopolymer compositions formed from ungraded/unclassified fly ash in order to increase the resultant strength of the manufactured sintered geopolymer articles. In general, semi dry pressing/compaction and dry pressing/compaction processes require less water to be added to the geopolymer composition, otherwise the article will be squeezed.

Following the forming process step, the formed geopolymer articles may be directed to an optional drying and/or preheating process step prior to firing process step. In an embodiment, the geopolymer article is subjected to heat treatment at temperatures of between 40° C. to 110° C. to reduce the amount of water in the geopolymer article and/or to allow the geopolymer article to gain sufficient strength to retain its shape during the manufacturing process. In an embodiment, the geopolymer article may be dried at room/ambient temperature for a period of between 2 hours to 7 days to gain the sufficient green strength. In an embodiment, the green strength of the geopolymer article is sufficient to retain its shape during the manufacturing process without performing any drying and/or per-heating step. In an embodiment, any waiting periods and/or drying step and/or preheating step may not be required, and the formed geopolymer article may be immediately directed to the firing process step, which may in turn reduce energy and processing time and increase throughput.

Following the forming process step or the optional drying/pre-curing step, the geopolymer article may be directed to a firing process step performed in a sintering/firing apparatus. The sintering/firing apparatus may be of any suitable type depending on the properties of the geopolymer composition, the required sintering temperature, the required sintering time, and the required properties of the produced sintered geopolymer article.

In an embodiment, the sintering/firing apparatus may employ various sintering techniques such as a conventional sintering technique, a microwave sintering technique, a microwave hybrid sintering technique, a microwave assisted sintering technique, a combination of conventional and microwave sintering technique, pressure sintering technique, pressure-assistant sintering technique or otherwise. Examples of suitable sintering/firing apparatuses include, but are not limited to, conveyor furnace, strand sintering furnace, roller kiln, roller hearth kiln, shuttle kiln, tunnel kiln, rotary kiln, microwave sintering furnace, microwave hybrid sintering furnace, microwave assisted sintering furnace and microwave rotary kiln. In an embodiment, the firing/sintering technique to be used may depend on the required geopolymer article size and shape, the type of forming technique used and the required properties of the sintered geopolymer article. For example, it may be preferable to produce sintered geopolymer aggregates in a rotary kiln if a pelletising technique is used to produce rounded articles, as a rotary kiln is suitable to sinter articles of a rounded shape. It may also be preferable to produce sintered geopolymer tiles using a conveyor or strand sintering furnace to minimize breaking or deforming the article shape during firing. Other considerations including initial costs, maintenance and footprint, as well as energy consumption and production capacity may also factors into the selection of a firing technique.

In an embodiment, the firing process may be performed as a continuous process.

In an embodiment, the firing process may be performed as a staged process.

In an embodiment, the firing process may comprise surface coating stage for glazing and/or decorating and/or coloring and/or sealing the geopolymer article using ceramic materials and equipment to produce sintered geopolymer articles with the required properties. The surface of the geopolymer article may also be shaped with patterns or imprints as desired.

The firing process step may comprise more than one stage performed in one or more than one firing apparatus. The firing process step may comprise drying stage, preheating stage, calcination stage, sintering stage or any combination thereof.

In some embodiments, calcination stage and sintering stage are performed in the same firing apparatus such as rotary kiln. In some embodiments, calcination stage is performed in a separate firing apparatus such as a calciner kiln.

In an embodiment the drying stage and/or preheating stage and/or calcination stage and/or sintering stage may be performed during the firing process step in one or more than one apparatus. In an embodiment, the drying stage and/or pre-curing stage and/or calcination stage and/or sintering stage may be performed in the same firing apparatus such as a rotary kiln, a tunnel kiln, a conveyor furnace, a strand sintering furnace or a roller kiln by controlling the heating rate during firing process.

In an embodiment, the firing process step may comprise a preheating stage where the geopolymer article is subjected to heat treatment at temperatures of between 150° C. to 800° C. to remove unburnt carbon and organic matter from the geopolymer article and accordingly avoid bloating and/or swelling of the geopolymer article during firing step, which is not a desirable technical property of some sintered articles such as tiles, bricks and pavers. In an embodiment, the preheating stage may not be performed as the unburnt carbon and organic matter in the geopolymer composition may act as a bloating agent to promote bloating mechanism which may produce a sintered geopolymer article of low density which is a desirable technical property of some sintered geopolymer articles such as sintered lightweight aggregates, floating aggregates or expanded lightweight aggregates.

In an embodiment, the firing process step may comprise a calcination stage (preferably for non-fired aluminosilicate precursors such as clay, shale and mine tailing) in which the geopolymer composition is subjected to heat treatment at temperatures of between 300° C. to 800° C., where the aluminosilicate precursor of the geopolymer composition may undergo alkali fusion process and/or alkali thermal activation process and/or dihydroxylation process and/or exothermic re-crystallisation process to change the mineralogical composition, decrease the crystallinity and increase the amorphous phase content and reactivity of the aluminosilicate materials in the geopolymer composition, and accordingly increase the dissolution of the aluminosilicate materials and improve the geopolymerisation process during the next firing stage (i.e. sintering stage). In a preferred embodiment, the melting point of one or more components of the alkali activating agent is at temperature of from 300° C. to 800° C.

In an embodiment, the inventor has found that the use of microwave hybrid sintering technique resulted in sintered geopolymer articles with superior strength characteristics being produced in a relatively short sintering time. Without wishing to be bound by theory, it is thought that the short sintering time achieved by microwave hybrid sintering is due to the volumetric nature of microwave heating.

In an embodiment, the geopolymer composition in the geopolymer article is subjected to a sintering temperature of from 800° C. to 1500° C. during at least a portion of the firing step. In an embodiment, the geopolymer article is immediately introduced to the sintering/firing apparatus, which may be set at the required sintering temperature. In an embodiment, the geopolymer article is immediately subjected to a sintering temperature of from 800° C. to 1500° C. during the firing step. In an embodiment, the geopolymer article is heated to the sintering temperature at a rate greater than or equal to 600° C./minute during at least a portion of the firing step. In an embodiment, the geopolymer article is heated to the sintering temperature at a rate greater than or equal to 200° C./minute during at least a portion of the firing step. In an embodiment, the geopolymer article is heated to the sintering temperature at a rate greater than or equal to 100° C./minute during at least a portion of the firing step. In an embodiment, the geopolymer article is heated to the sintering temperature at a rate greater than or equal to 50° C./minute during at least a portion of the firing step. In an embodiment, the geopolymer article is heated to the sintering temperature at a rate greater than or equal to 10° C./minute during at least a portion of the firing step. In an embodiment, the geopolymer article is heated to the sintering temperature at a rate greater than or equal to 5° C./minute during at least a portion of the firing step.

In an embodiment, the duration of sintering stage is less than or equal to 120 minutes. In an embodiment, the duration of sintering stage is less than or equal to 60 minutes. In an embodiment, the duration of sintering stage is less than or equal to 30 minutes. In an embodiment, the duration of sintering stage is less than or equal to 15 minutes. In an embodiment, the duration of sintering stage is less than or equal to 5 minutes. In an embodiment, the duration of sintering stage is less than or equal to 1 minute.

Following the firing process step, the sintered geopolymer article may be collected into a cooling apparatus to rapidly cool the geopolymer article to ambient temperature. The heat may be recovered from the cooling apparatus and used for heating and/or preheating of the firing apparatus or used for steam and/or electrical power generation.

In embodiment, the geopolymer article may be cooled at ambient conditions.

In an embodiment, the geopolymer article may be cooled at a rate greater than or equal to 600° C./minute during at least a portion of the cooling step.

In an embodiment, the geopolymer article may be cooled at a rate greater than or equal to 200° C./minute during at least a portion of the cooling step.

In an embodiment, the geopolymer article may be cooled at a rate greater than or equal to 100° C./minute during at least a portion of the cooling step.

In an embodiment, the geopolymer article may be cooled at a rate greater than or equal to 50° C./minute during at least a portion of the cooling step.

In an embodiment, the geopolymer article may be cooled at a rate greater than or equal to 10° C./minute during at least a portion of the cooling step.

In an embodiment, the geopolymer article may be cooled at a rate greater than or equal to 5° C./minute during at least a portion of the cooling step.

Preferably, the forming process step and the firing process step are adapted such that the sintered geopolymer articles produced by the firing apparatus are of the desired size and dimensions, such as aggregates, proppants, tiles, building elements, sheeting, slabs, roof tiles and bricks for example. However, in some embodiments, the sintered geopolymer articles may be optionally processed by a sizing process step to produce articles to the required size specification. The sizing process step may include a crushing apparatus to reduce the size of the articles, and a sieving apparatus to separate the crushed articles into the required size fractions. In an embodiment, the sintered geopolymer articles produced by the firing process step may be in the form of tiles, bricks, sheets, masses or large size aggregates that may be processed by a sizing step to produce sintered geopolymer aggregates of desired sizes.

In an embodiment, a geopolymer article may be formed by the general steps of forming a geopolymer composition and sintering the geopolymer article. In an embodiment, sintered geopolymer articles with good strength characteristics may be formed from aluminosilicate precursors with varying properties, including ungraded/unclassified fly ashes with poor reactivities by adjusting the relative quantities of the geopolymer composition components, adjusting the forming technique as well as the agglomeration/granulation apparatus and process variables used, and adjusting the firing technique as well as the firing/sintering apparatus and process variables used such as sintering temperature, sintering time and heating and/or cooling rate.

In an embodiment, sintered geopolymer articles having different properties in terms of strength, density, porosity, absorption capacity, as well as other properties may be produced by selecting/adjusting/controlling:

the properties and chemical compositions of the aluminosilicate precursor, alkali activating agent and other additives;

the relative quantities of the components of the geopolymer composition;

the forming technique as well as the agglomeration/granulation apparatus and process variables used; and

the firing technique as well as the firing/sintering apparatus and process variables used such as sintering temperature, sintering time and heating and/or cooling rate. Accordingly, the present invention is adaptable to manufacture sintered geopolymer articles for various applications.

As described herein and with reference to the examples, the process of the present invention may offer certain advantages in the manufacture of sintered geopolymer articles. In an example advantage, for a particular sintering time and alkali activating agent content, the strength of the sintered geopolymer article may be increased by increasing the sintering temperature. Similarly, for a particular sintering temperature, the strength of the sintered geopolymer article may be increased by increasing the alkali activating agent content. Similarly, for a particular alkali activating agent content and sintering temperature, the strength of the sintered geopolymer article may be increased by increasing the sintering time. Similarly, for a particular alkali activating agent content, sintered geopolymer articles of equivalent strength may be produced by increasing sintering temperature and decreasing sintering time or vice versa. Still further, sintered geopolymer articles of different properties such as strength, density, porosity and absorption capacity may be produced by selection of alkali activating agent content, sintering temperature and sintering time. Still further, for a particular alkali activating agent content, sintering time and sintering temperature, the strength of sintered geopolymer articles may be increased by increasing the compaction pressure applied during the forming process step. Similarly, for a particular alkali activating agent content, compaction pressure and sintering temperature, the strength of the sintered geopolymer articles may be increased by increasing the sintering time. Similarly, for a given alkali activating agent content, compaction pressure and sintering time, the strength of the sintered geopolymer articles may be increased by increasing the sintering temperature. Similarly, for a given compaction pressure, sintering time and sintering temperature, the strength of sintered geopolymer articles may be increased by increasing alkali activating agent content. Yet further by controlling of the combination of particle size and particle size distribution of the dry components of the geopolymer composition, the content and properties of the aluminosilicate precursor components, the water content, the content and properties of the alkali activating agent components, the content and properties of other additives, the compaction pressure, the heating rate, the sintering temperature, the sintering time and cooling rate the properties of the sintered geopolymer articles such as strength, density, porosity, absorption capacity and initial rate of absorption can be adjusted to cater for the particular technical demand of application of the end product.

The embodiments for producing sintered geopolymer articles as herein described may find particular application in the manufacture of sintered geopolymer aggregates. These sintered geopolymer aggregates may be less dense than natural aggregates and accordingly, may constitute a premium product for the production of concrete. Example applications of the sintered geopolymer aggregates as herein described may include structural lightweight concrete, high strength lightweight concrete, floating concrete, concrete blocks, precast units, panels, cladding, composite cladding, lightweight roof tiles, structural fill, floor and roof screed, drainage and filter media and refractory uses. The sintered lightweight geopolymer aggregates with their particular characteristics, which may include high strength, low density and low absorption capacity, may allow for the production of lightweight concrete, which is commonly used for large structures such as multi-story buildings. Use of such lightweight concrete may reduce the total mass of structures and foundations, which may lead to savings in construction costs. The sintered lightweight geopolymer aggregates may also enhance fire resistance and thermal insulation when used in concrete and refractory elements. In an embodiment, sintered geopolymer lightweight aggregates of low specific gravity that float on water was produced using this invention. This manufactured Sintered geopolymer lightweight aggregate has a high porous structure but with low water absorption capacity. This has an advantage to the pumice stone aggregates, which has a higher water absorption capacity.

The methods described herein may be used to produce sintered geopolymer aggregates that can replace natural aggregates and/or synthetic/artificial aggregates. In addition, the inventive alkali-activated sintering manufacturing process described herein, may replace and/or modify and/or optimise the existing sintered aggregate manufacturing processes. Examples of existing sintered aggregate products are sintered fly ash aggregates (such as Lytag™) and lightweight expanded clay aggregates (such as Leca, Argex, Litagg, laterlite and Liapor).

The methods described herein may also be used to produce sintered geopolymer proppants that can replace natural frac sand and/or ceramic proppants used in oil and gas industries. In addition, the inventive alkali-activated sintering manufacturing process described herein, may replace and/or modify and/or optimise the existing ceramic proppant manufacturing processes.

The methods described herein may also be used to produce sintered geopolymer bricks, pavers and tiles that can replace fired clay bricks, fired clay tiles, ceramic tiles and other sintered clay-based ceramic products. In addition, the inventive alkali-activated sintering manufacturing process described herein, may replace and/or modify and/or optimise the existing sintered clay-based ceramic manufacturing processes.

### EXAMPLES

Provided herein are some non-limiting example embodiments which describe the present invention and the various products that can be made using some embodiments of the present invention described herein. It is to be understood that fly ashes used in these example embodiments as aluminosilicate precursor are for demonstration purposes only, and that any aluminosilicate precursor can be used. Further, it is to be understood that alkali activating agent used in these example embodiments are also for demonstration purposes only, and that any alkali activating agent can be used.

### Example 1

Provided is an example embodiment for producing sintered geopolymer articles of superior compressive strength using the non-pressure technique in the forming process. A classified fly ash was used as an aluminosilicate precursor and a relatively low water content in the geopolymer composition were used in the experiments. A microwave hybrid heating/firing system was used as a firing/sintering technique. It is to be understood that the use microwave hybrid firing/sintering system used in this example embodiment is for demonstration purposes only, and that other firing/sintering techniques are equally suitable for use.

Since the strength of the sintered geopolymer articles (especially aggregates and proppants) is one of the most important quality indicators, the geopolymer compositions were made into cylindrical geopolymer articles to ensure that the characteristics of the sintered geopolymer articles to be clearly obtained by compression test. It is to be understood that the pressing die set used (in the experiments of this example embodiment) to form the geopolymer articles is for shaping purposes only and the applied pressure (less than 0.5 MPa) was very low and negligible. Accordingly, the forming process performed during the experiments of this example embodiment should be not be considered as a pressure forming process.

A water content of 28 wt % of the total weight of the geopolymer composition was intentionally selected and used in the experiments of this example embodiment, which was the same amount of water required to form the same geopolymer composition into rounded shape articles (such as aggregates and proppants) using a disc pelletiser. Accordingly, the same geopolymer composition may be formed by a non-pressure agglomeration/granulation apparatus to produce geopolymer aggregates and geopolymer proppants and then sintered using the same microwave hybrid sintering technique used in the experiments conducted herein or any other suitable firing/sintering technique. Again, the purpose of using the pressing die set was to make a cylinder-shape articles suitable for performing compression test as discussed hereinabove.

The experiments were conducted by the inventor to investigate and show the differences between the conventional geopolymer curing process and the new alkali-activating sintering process. The classified fly ash used contains 25.56 wt % Al₂O₃, 51.11 Wt % SiO₂, 12.48 wt % Fe2O3, 4.3 wt % CaO, 0.7 wt % K₂O, 1.45 wt % MgO, 0.77 wt % Na₂O, 0.89 wt % P₂O₅, 1.32 wt % TiO₂, 0.15 wt % Mn₃O₄, 0.24 wt % SO₃ with LOI (loss on ignition) of 0.57 wt %. This fly ash has a specific gravity of 2.35, a fineness (passing 45 μm) of 95%, and an average particle size of 7 μm. Sodium metasilicate anhydrous in a granular powder solid form and commercially available from Redox Pty Ltd was used as an alkali activating agent. The Sodium metasilicate anhydrous contains 52 wt % Na₂O and 47 wt % SiO₂ with a total solids content of 99 wt % and water content of 1 wt % of the total weight of the sodium metasilicate anhydrous granular powder. The melting point of the sodium metasilicate anhydrous is 1088° C. An alkali activating solution was made by dissolving the required amount of sodium silicate anhydrous granular powder in tap water. The water content used in the alkali activating solution was 18 wt % of the total weight of the geopolymer composition. The alkali activating agent content used was 4 wt % of the dry weight of the geopolymer composition. The geopolymer composition was prepared by mixing the dry fly ash with the alkali activating solution in a mechanical mixer for 10 minutes. A 20 mm diameter pressing die set was used to make cylindrical articles from the geopolymer composition batches. Each geopolymer article was formed from 5 g of the geopolymer composition batch. A minimal pressure (less than 0.5 MPa) was applied by hand to shape and form the geopolymer articles. The articles diameter was 20 mm and the average articles height was between 11-12 mm. Two different apparatuses were used individually to cure the geopolymer articles, namely a conventional dry oven and a microwave oven containing a microwave kiln. The microwave kiln is an aluminosilicate refractory with a special internal lining made of silicon carbide called microwave susceptor that absorbs microwave energy, converts it into heat, and transfers the heat to the article. The microwave kiln used can reach a temperature of 800° C. in about 5 minutes when a microwave power of 1200 W is used. The geopolymer articles were placed directly inside the curing apparatus without waiting period or drying or preheating step. Twenty geopolymer articles were placed inside a pre-heated conventional dry oven set at a temperature of 90° C. and cured for 24 hours. Another 20 geopolymer articles were placed inside a microwave kiln which was then placed inside the microwave oven and cured for 15 minutes at 1200 W microwave power. The microwave kiln was immediately removed from the microwave oven after curing and the lid of the microwave kiln was removed to allow rapid cooling of the sintered geopolymer articles to the ambient room temperature. The compressive strength of three cured/sintered geopolymer articles form each curing process (i.e. oven curing and microwave hybrid sintering) were assessed and the average compressive strength was recorded. Other cured articles were used for other tests. Table 1 shows the properties of the cured/sintered geopolymer articles.

TABLE 1

| | | Compressive | Bulk | Water | Volume |
|---|---|---|---|---|---|
| | Curing | strength | density | absorption | change |
| Curing process | time | (MPa) | (g/cm³) | (%) | (%) |
| Oven curing | 24 hr | 2.47 | 1.40 | 28 | 0.10 |
| Microwave hybrid sintering | 15 min | 276 | 1.69 | 4 | −10.51 |

The results show that the oven-cured geopolymer articles exhibited poor mechanical and physical properties. The compressive strength of the oven-cured geopolymer articles was only 2.47 MPa and the water absorption capacity was 28%. It can be concluded that the conventional geopolymer process is not efficient in producing geopolymer articles of good properties when the geopolymer articles are formed form a geopolymer composition comprising low water and alkali activating agent contents. On the other hand, the results show that the geopolymer articles cured using the new alkali-activated sintering process have exhibited excellent mechanical and physical properties. Sintered geopolymer articles of a superior compressive strength of 276 MPa and a low water absorption capacity of 4% were produced using a very short curing time of 15 minutes.

The temperatures of the microwave kiln during heating were recorded to investigate the rapid heating process. Table 2 shows the microwave kiln temperatures during microwave operation at 1200 W microwave power. It can be concluded from Table 2 that, in general, the heating rate was decreasing as the firing time increasing. The microwave kiln heating rate was very high at a rate of 180-200° C./min during the first 3 minutes, then the heating rate decreased to a rate of 80-110° C./min during the next two minutes. After that, the heating rate has further decreased to a rate of 30-60° C./min.

TABLE 2
Microwave kiln temperatures during operation at 1200 W microwave power.

| | Firing time (min) | | | | | | | | | | | | | | | |
|---|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 | 15 |
| Microwave | 23 | 195 | 390 | 580 | 710 | 800 | 865 | 911 | 942 | 1004 | 1060 | 1097 | 1124 | 1152 | 1176 | 1197 |
| kiln temp. | | | | | | | | | | | | | | | | |
| (° C.) | | | | | | | | | | | | | | | | |

The geopolymer articles did not disintegrate or burst during rapid firing step. It can be concluded form the results that the geopolymer articles may be fired rapidly at a rate of 200° C./min. In an embodiment, the geopolymer articles may be rapidly fired at a rate of greater than 200° C./min during at least a portion of the firing step. The volumetric nature of microwave heating and the rapid heating has significant effect on the sintering process. In a preferable embodiment, microwave hybrid sintering technique may be used to produce sintered geopolymer articles of superior properties.

To investigate the rapid cooling process, an infrared non-contact thermometer was used to record the surface temperature of the sintered geopolymer articles during rapid cooling to the ambient room temperature. The readings, as shown in Table 3, indicate that the cooling rate was extremely high during the first minute at a rate of greater than 600° C./min, and then slowed down into a rate of between 50° C./min and 200° C./min during the following three minutes. After that, the cooling rate has slowed down further from up to 40° C./min during the following minutes to up to 3° C./min during the last few minutes.

TABLE 3
Sintered geopolymer article surface temperatures during rapid cooling step.

| | Cooling time (min) | | | | | | | | | | | |
|---|---|---|---|---|---|---|---|---|---|---|---|---|
| | 0 | 1 | 2 | 3 | 4 | 5 | 7 | 9 | 11 | 13 | 15 | 25 |
| Article | 1197 | 588 | 387 | 281 | 231 | 192 | 125 | 104 | 85 | 68 | 59 | 28 |
| surface | | | | | | | | | | | | |
| temp. (° C.) | | | | | | | | | | | | |

No cracks were observed in the sintered geopolymer articles after rapid cooling step. It can be concluded form the results that the geopolymer articles may be cooled rapidly at a rate of between 50° C./min to 600° C./min after sintering. In an embodiment, the sintered geopolymer articles may be rapidly cooled at a rate of greater than 600° C./min during at least a portion of the cooling step. In an embodiment, the sintered geopolymer articles may be rapidly cooled at a rate of between about 50° C./min to about 200° C./min during at least a portion of the cooling step. The heat may be recovered from the cooling apparatus and used for heating of the sintering apparatus or used for steam and/or electrical power generation.

### Example 2

Provided is an example embodiment for producing sintered geopolymer articles using the non-pressure technique in the forming process and an ungraded/unclassified fly ash (i.e. run of station fly ash) as an aluminosilicate precursor.

Experiments were conducted by the inventor to investigate the effect of sintering temperature and the alkali activating agent content on the properties of the sintered geopolymer articles. The ungraded/unclassified fly ash used contains 25.5 wt % Al₂O₃, 55.3 wt % SiO₂, 7.6 wt % Fe₂O₃, 4.1 wt % CaO, 1.2 wt % K₂O, 0.8 wt % MgO, 0.4 wt % Na₂O, 0.44 wt % P₂O₅, 1.65 wt % TiO₂, 0.08 wt % Mn₃O₄, 0.18 wt % SO₃ with LOI (loss on ignition) of 1.41 wt %. This fly ash has a specific gravity of 2.1, a fineness (passing 45 μm) of 62%, and an average particle size of 40 μm. The same alkali activating agent, materials preparation, mixing, forming and testing procedures used in the experiments conducted in example embodiment 1 were used in this example embodiment. The water content in all alkali activating solutions was fixed at 28 wt % of the total weight of the geopolymer composition which was the same amount of water required to form the same geopolymer composition into rounded shape articles (such as aggregates and proppants) using a disc pelletiser. Three different alkali activating agent contents were used, namely 2 wt %, 6 wt % and 10 wt % of the dry weight of the geopolymer composition. Three batches of geopolymer compositions were prepared with varying fly ash and alkali activating agent contents using the prepared alkali activating solutions. The formed articles diameter was 20 mm and the average articles height was between 11-12 mm. The green geopolymer articles were then fired (without waiting period or drying or preheating step) in a pre-heated muffle furnace set at the required sintering temperature and sintered for the required sintering time (15 minutes). After that, the geopolymer articles were unloaded from the muffle furnace and left to rapidly cool at ambient temperature. Four different sintering temperatures were used namely, 1000° C., 1100° C., 1200° C. and 1250° C. A sintering time of 15 minutes was used in all experiments. A total of 12 groups of geopolymer articles (with each group consists of six articles) were formed with varying geopolymer compositions then sintered at various sintering temperatures. After cooling, the compressive strength of three sintered geopolymer articles for each group were assessed and the average compressive strength was recorded. Other sintered geopolymer articles were used for other tests. Table 4 shows the geopolymer composition batches proportions, sintering temperatures and testing results of the sintered geopolymer articles. It should be mentioned here that, in table 4, a negative volume change value represents volume shrinkage while a positive volume change value represents volume expansion.

The geopolymer articles did not disintegrate or burst during the rapid firing step. It can be concluded form the results that the geopolymer articles may immediately be subjected to the required sintering temperature. In an embodiment, the geopolymer articles may immediately be fired at the required sintering temperature. In an embodiment, the geopolymer articles may be rapidly fired at a rate of greater than 600° C./min during at least a portion of the firing step.

The results show that for geopolymer compositions formed with alkali activating agent contents of 2 wt % and 6 wt %, the compressive strength of the sintered geopolymer articles increased as the sintering temperature increased up to a temperature of 1200° C. then decreased at a temperature of 1250° C. In addition, for a geopolymer composition formed with alkali activating agent content of 10 wt %, the compressive strength of the sintered geopolymer articles increased as the sintering temperature increased up to a temperature of 1100° C. then decreased as the sintering temperature increased (i.e. at temperatures of 1200° C. and 1250° C.). Furthermore, a geopolymer composition formed with an alkali activating agent content of as low as 2 wt % by weight of the geopolymer composition can be used to produce sintered geopolymer articles of an excellent strength of 40 MPa using a sintering temperature of 1200° C. and a sintering time of 15 minutes.

The results also show that for a geopolymer composition formed with an alkali activating agent content of 2 wt %, the density of the sintered geopolymer articles increased as the sintering temperature increased up to a temperature of 1200° C. then decreased at a temperature of 1250° C. On the other hand, for a geopolymer composition formed with an alkali activating agent content of 10 wt %, the density of the sintered geopolymer articles decreased as the sintering temperature increased for all sintering temperatures higher than 1000° C.

TABLE 4:

| | Fly | Alkali | Sintering | Compressive | Bulk | Water | Volume |
|---|---|---|---|---|---|---|---|
| Group | ash | agent | temp. | strength | density | absorption | change |
| no. | (wt %) | (wt %) | (° C.) | (MPa) | (g/cm³) | (%) | (%) |
| 1 | 98 | 2 | 1000 | 1.19 | 0.99 | 47.31 | 1.96 |
| 2 | 98 | 2 | 1100 | 12.16 | 1.09 | 35.38 | −7.35 |
| 3 | 98 | 2 | 1200 | 40.47 | 1.3 | 17.48 | −22.36 |
| 4 | 98 | 2 | 1250 | 35.92 | 1.19 | 6.98 | −15.63 |
| 5 | 94 | 6 | 1000 | 18.22 | 1.14 | 31.98 | −10.46 |
| 6 | 94 | 6 | 1100 | 27.17 | 1.18 | 23.86 | −13.31 |
| 7 | 94 | 6 | 1200 | 38.67 | 1.16 | 7.34 | −11.75 |
| 8 | 94 | 6 | 1250 | 13.76 | 0.95 | 5.81 | 7.66 |
| 9 | 90 | 10 | 1000 | 24.65 | 1.18 | 25.19 | −11.75 |
| 10 | 90 | 10 | 1100 | 39.37 | 1.12 | 14.57 | −8.13 |
| 11 | 90 | 10 | 1200 | 9.01 | 0.97 | 7.07 | 5.33 |
| 12 | 90 | 10 | 1250 | 4.18 | 0.91 | 8.29 | 13.35 |

The results also show that for a geopolymer composition formed with an alkali activating agent content of 2 wt %, the volume of sintered geopolymer articles decreased (i.e. the article shrinks) as the sintering temperature increased up to a temperature of 1200° C. then the volume of sintered geopolymer articles increased at a temperature of 1250° C. (i.e. the article expands). On the other hand, for a geopolymer composition formed with an alkali activating agent content of 10 wt %, the volume of the sintered geopolymer articles decreased at a sintering temperature of 1000° C., then volume of the sintered geopolymer articles increased as the sintering temperature increased for all sintering temperatures higher than 1000° C.

The results also show that, for a geopolymer composition formed with a specific alkali activating agent content (i.e 2 wt %, 6 wt % or 10 wt %), the water absorption capacity of the sintered geopolymer articles decreases as the sintering temperature increases. On the other hand, when various geopolymer compositions sintered at a specific sintering temperature (i.e. a 1000° C., 1100° C., 1200° C. or 1250° C.), the water absorption capacity of the sintered geopolymer articles decreases as the alkali activating agent content in the geopolymer composition increases.

Without wishing to be bound by theory, the inventor believes that when geopolymer articles formed from geopolymer compositions of low alkali activating agent contents (i.e. 2 wt % and 6 wt %) are sintered at low sintering temperatures (i.e. 1000° C. and 1100° C.), the dissolution and activation of the fly ash particles and the initiation of the alkali-activated sintering phase and formation of viscous geopolymer gels will increase the fusion of the fly ash particles and increase articles densification which decrease the volume and increase the density and strength of the sintered geopolymer articles. In addition, the formation of the viscous and/or eutectic geopolymer gels during alkali-activating sintering phase will lead to the filling of the spaces between fly ash particles which in turn decreases the porosity and water absorption capacity and increases the density and strength of the produced sintered geopolymer articles. On other hand, increasing the content of the alkali activating agent in the geopolymer composition to a higher level (i.e. 10 wt %) and/or increasing the sintering temperature above 1100° C. will increase the rate of dissolution and fusing of the fly ash particles and increase the amount of viscous and/or eutectic geopolymer gels inside the article and the vitrification of the article outer layer, which will trap any existing gases and/or vapours and promotes bloating mechanism and therefore increases the volume of the article and consequently reduces the density and strength of the produced sintered geopolymer article. The continuous decrease in the water absorption capacity despite the decrease in the density and the increase in the volume of the sintered geopolymer article is most likely due to the formation of more impervious pores.

It can be concluded from the above results that sintered geopolymer articles of various properties can be produced using the present invention and that the strength, density, absorption capacity and other properties of the sintered geopolymer articles can be regulated/controlled by alkali activating agent content and sintering temperature.

### Example 3

Provided is another example embodiment for producing sintered geopolymer articles using the non-pressure technique in the forming process and an ungraded/unclassified fly ash (i.e. run of station fly ash) as an aluminosilicate precursor in the geopolymer composition. Experiments were conducted by the inventor to investigate the effect of sintering temperature, sintering time, alkali activating agent content and water content on the properties the produced sintered geopolymer articles. The same materials (i.e. fly ash and alkali activating agent) and the same materials preparation, mixing, forming, firing, cooling and testing procedures used in the experiments conducted in example 2 were also used in this example embodiment. Two different alkali activating agent contents were used, namely 4 wt % and 8 wt % of the dry weight of the geopolymer composition. Two different water contents were also used namely, 18 wt % and 28 wt % of the total weight of the geopolymer composition. Four different geopolymer compositions batches were prepared as shown in Table 5. Three different sintering temperatures were used, namely 1100° C., 1200° C. and 1250° C. In addition, three sintering times were used, namely 5, 10 and 15 minutes. A total of 36 groups of sintered geopolymer articles (with each group consists of six articles) were produced and tested. Tables 6 to 9 tabulate the properties of the sintered geopolymer articles formed from the geopolymer composition batches.

TABLE 5
Geopolymer compositions batch proportions.

| Batch number | 1 | 2 | 3 | 4 |
|---|---|---|---|---|
| Fly ash content (wt % of dry weight) | 96 | 92 | 96 | 92 |
| Alkali activating agent content | 4 | 8 | 4 | 8 |
| (wt % of dry weight) | | | | |
| Water content (wt % of total weight) | 28 | 28 | 18 | 18 |

The results show that the alkali activating agent content, water content, sintering temperature and sintering time have important roles in developing the physical and mechanical properties of the sintered geopolymer articles. Sintered geopolymer articles having different properties in terms of strength, density, porosity, absorption capacity, as well as other properties may be produced by selecting/adjusting/controlling the geopolymer composition components content (i.e. the alkali activating agent and water content) and the firing process variables (i.e. sintering temperature and sintering time).

The results also show that a sintered geopolymer article of an excellent compressive strength can be produced using a firing/sintering time of 5 minutes. For example, a sintered geopolymer article having a compressive strength of 60 MPa was produced using a sintering temperature of 1200° C. and a sintering time of 5 minutes (as seen in Table 8). Further, the results also show that a sintered geopolymer article of a low density and low water absorption capacity can be produced using the process of the present invention. For example, a sintered geopolymer article having a density of 0.85 g/cm³ and a water absorption capacity of 9.6% was produced using a sintering temperature of 1250° C. and a sintering time of 15 minutes (as seen in Table 7). This may be advantageous in that; it can be used in structural concrete applications in which lightweight aggregates having water absorption capacity of less than 10% is recommended. In addition, sintered lightweight geopolymer aggregates of low density and high water absorption capacity can be produced which can be used in other concrete applications such as concrete masonry and non-concrete applications which require lightweight aggregates with high water absorption capacity.

TABLE 6
Results of geopolymer composition batch no. 1

| | | | Compres- | | | |
|---|---|---|---|---|---|---|
| | Sintering | Sintering | sive | Bulk | Water | Volume |
| Group | temp. | time | strength | density | absorption | change |
| no. | (° C.) | (min) | (MPa) | (g/cm³) | (%) | (%) |
| 1 | 1100 | 5 | 13.84 | 1.13 | 32.83 | −9.17 |
| 2 | 1100 | 10 | 19.91 | 1.15 | 30.79 | −11.24 |
| 3 | 1100 | 15 | 22.95 | 1.16 | 30.1 | −12.27 |
| 4 | 1200 | 5 | 30.61 | 1.21 | 23.27 | −16.67 |
| 5 | 1200 | 10 | 51.52 | 1.29 | 10.97 | −21.07 |
| 6 | 1200 | 15 | 56.67 | 1.28 | 10.46 | −20.55 |
| 7 | 1250 | 5 | 45.67 | 1.27 | 14.43 | −20.81 |
| 8 | 1250 | 10 | 38.6 | 1.21 | 9.72 | −16.67 |
| 9 | 1250 | 15 | 27.96 | 1.17 | 9.54 | −13.82 |

TABLE 7
Results of geopolymer composition batch no. 2

| | | | Compres- | | | |
|---|---|---|---|---|---|---|
| | Sintering | Sintering | sive | Bulk | Water | Volume |
| Group | temp. | time | strength | density | absorption | change |
| no. | (° C.) | (min) | (MPa) | (g/cm³) | (%) | (%) |
| 1 | 1100 | 5 | 32.68 | 1.24 | 24.06 | −16.41 |
| 2 | 1100 | 10 | 44.91 | 1.2 | 18.09 | −13.82 |
| 3 | 1100 | 15 | 44.94 | 1.2 | 16.75 | −15.38 |
| 4 | 1200 | 5 | 44.87 | 1.13 | 12.25 | −8.13 |
| 5 | 1200 | 10 | 30.47 | 1.07 | 8.91 | −5.28 |
| 6 | 1200 | 15 | 18.49 | 1.03 | 8.31 | −0.37 |
| 7 | 1250 | 5 | 25.89 | 1.01 | 12.05 | −0.11 |
| 8 | 1250 | 10 | 9.55 | 0.9 | 12.12 | 13.35 |
| 9 | 1250 | 15 | 6.92 | 0.85 | 9.6 | 20.85 |

TABLE 8
Results of geopolymer composition batch no. 3

| | | | Compres- | | | |
|---|---|---|---|---|---|---|
| | Sintering | Sintering | sive | Bulk | Water | Volume |
| Group | temp. | time | strength | density | absorption | change |
| no. | (° C.) | (min) | (MPa) | (g/cm³) | (%) | (%) |
| 1 | 1100 | 5 | 9.06 | 1.04 | 35.08 | −2.76 |
| 2 | 1100 | 10 | 15.4 | 1.09 | 29.38 | −7.22 |
| 3 | 1100 | 15 | 10.71 | 1.09 | 29.38 | −8.61 |
| 4 | 1200 | 5 | 22.18 | 1.16 | 18.4 | −14.15 |
| 5 | 1200 | 10 | 43.15 | 1.19 | 14.49 | −15.73 |
| 6 | 1200 | 15 | 43.39 | 1.21 | 12.37 | −17.26 |
| 7 | 1250 | 5 | 60.58 | 1.17 | 9.43 | −13.87 |
| 8 | 1250 | 10 | 44.74 | 1.08 | 5.81 | −6.72 |
| 9 | 1250 | 15 | 37.67 | 1.01 | 5.55 | −0.19 |

TABLE 9
Results of geopolymer composition batch no. 4

| | | | Compres- | | | |
|---|---|---|---|---|---|---|
| | Sintering | Sintering | sive | Bulk | Water | Volume |
| Group | temp. | time | strength | density | absorption | change |
| no. | (° C.) | (min) | (MPa) | (g/cm³) | (%) | (%) |
| 1 | 1100 | 5 | 22.78 | 1 | 26.51 | −3.99 |
| 2 | 1100 | 10 | 26.71 | 1.01 | 24.64 | −5.09 |
| 3 | 1100 | 15 | 31.78 | 1.04 | 19.87 | −7.6 |
| 4 | 1200 | 5 | 49.14 | 1.07 | 9.55 | −9.63 |
| 5 | 1200 | 10 | 36.26 | 1 | 6.07 | −4.31 |
| 6 | 1200 | 15 | 32.32 | 0.95 | 11.25 | 1.17 |
| 7 | 1250 | 5 | 26.22 | 0.93 | 13.82 | 2.61 |
| 8 | 1250 | 10 | 17.51 | 0.82 | 28.87 | 16.95 |
| 9 | 1250 | 15 | 10.18 | 0.76 | 34.17 | 26.79 |

### Example 4

Provided is an example embodiment for producing sintered geopolymer articles using ungraded/unclassified and graded/classified fly ashes as aluminosilicate precursors in the geopolymer composition. Experiments were conducted by the inventor to investigate the effect of the properties of the aluminosilicate precursor on the properties the produced sintered geopolymer articles. The same materials preparation, mixing, forming, firing, cooling and testing procedures used in the experiments conducted in example 2 were also used in this example embodiment. Two different fly ashes were used as aluminosilicate precursors to prepare two different geopolymer composition batches, namely the graded/classified fly ash used in Example 1 and the ungraded/unclassified fly ash used in Example 2. Same alkali activating agent content of 4 wt % of the dry weight of the geopolymer composition and water content of 18 wt % of the total weight of the geopolymer composition was used in the geopolymer compositions. The formed geopolymer articles were sintered at a temperature of 1000° C. for 15 minutes. Table 10 tabulate the properties of the sintered geopolymer articles formed from the geopolymer composition batches.

TABLE 10

| | Graded | Ungraded |
|---|---|---|
| Fly ash type | fly ash | fly ash |
| Compressive strength (MPa) | 100 | 6.2 |
| Water absorption (%) | 13.6 | 37.84 |
| Bulk density (g/cm³) | 1.72 | 1.03 |

The results show that the strength of sintered geopolymer article made with graded fly ash is 16 times higher than the strength of sintered geopolymer articles made with ungraded fly ash. It can be concluded that the properties of the aluminosilicate precursor significantly effect the properties of the sintered geopolymer articles.

### Example 5

Provided is an example embodiment for producing sintered geopolymer articles using the pressure technique in the forming process. Experiments were conducted by the inventor to investigate the effect of the amount of compaction pressure applied during the forming process on the produced sintered geopolymer articles. The same materials (i.e. the fly ash and the alkali activating agent), material preparation, mixing, forming, firing, cooling and testing procedures used in the experiments conducted in example 2 were also used in this example embodiment. An alkali activating agent content of 4 wt % of the dry weight of the geopolymer composition and water content of 10 wt % of the total weight of the geopolymer composition was used in the geopolymer compositions. Different compaction pressures were applied during the forming of the geopolymer articles, namely 1, 5, 10, 20, 30, 40 and 80 MPa. In addition, geopolymer articles formed by hand were also produced. The formed geopolymer articles were sintered at a temperature of 1150° C. for 15 minutes. Table 11 tabulate the properties of the sintered geopolymer articles formed from the geopolymer composition batches.

TABLE 11

| | Applied pressure (MPa) | | | | | | | |
|---|---|---|---|---|---|---|---|---|
| | <0.5 | 1 | 5 | 10 | 20 | 30 | 40 | 80 |
| Compressive | 29 | 37 | 58 | 71 | 83 | 94 | 100 | 124 |
| strength (MPa) | | | | | | | | |
| Water | 25.2 | 19.4 | 13.9 | 12.1 | 11.3 | 11.4 | 9.4 | 7.9 |
| absorption (%) | | | | | | | | |
| Bulk | 1.18 | 1.27 | 1.35 | 1.33 | 1.39 | 1.43 | 1.44 | 1.49 |
| density (g/cm³) | | | | | | | | |

The results show that the amount of compaction pressure applied during the forming of the geopolymer article significantly affect the properties of the sintered geopolymer articles. The compressive strength of the sintered geopolymer article can be increased by increasing the compaction pressure during forming step. Further, the water absorption capacity of the sintered geopolymer article can be decreased by increasing the compaction pressure during forming step.

### Example 6

Provided is an example embodiment for producing sintered geopolymer aggregates using the non-pressure technique in the forming process and using the produced sintered geopolymer aggregates for producing cement mortar articles.

Experiments were conducted by the inventor to investigate the use of the sintered geopolymer aggregates in concrete applications. The sintered geopolymer fine aggregates, which has been produced using the microwave hybrid sintering, was successfully used in the production of cement mortars. The ungraded fly ash used in example 2 was pelletised using disc pelletizer to produce geopolymer aggregates, then sintered in the microwave kiln at 1200 W for 15 minutes and then rapidly cooled to the ambient temperature using the same procedure detailed in example 1. An alkali activating agent content of 4 wt % of the dry weight of the geopolymer composition and water content of 28 wt % of the total weight of the geopolymer composition was used to make the alkali activating solution. The dry fly ash was fed into the disc pelletiser and sprayed with the alkali activating solution to make spherical geopolymer aggregates. The sintered geopolymer aggregate particle sizes were in the range of 0.6 to 2.3 mm. The sintered geopolymer aggregates were used to make cement mortar having a cement to sintered geopolymer aggregate volume ratio of 1:3 and a water to cement ratio of 0.5. The mortar was then moulded in cubic moulds with 50 mm edges. The mortar in moulds was compacted for 1 minute using a vibrating table. Mortar specimens were de-moulded after 24 hours and cured in a water tank at 23° C. for different curing ages namely; 7, 14 and 28 days. The properties of manufactured sintered geopolymer fine aggregate is shown in Table 12. Table 13 shows the compressive strength of the mortar specimens made using the sintered geopolymer aggregate.

TABLE 12

| | Density SSD | Absorption |
|---|---|---|
| Material | Kg/m³ | % |
| Sintered geopolymer fine aggregate | 1640 | 8 |

TABLE 13

| Curing Method | Water | | |
|---|---|---|---|
| Curing age (day) | 7 | 14 | 28 |
| Compressive strength (MPa) | 31 | 37 | 42 |

It can be concluded that the sintered geopolymer aggregates produce according to the process of the present invention can be used as a replacement to natural aggregates in concrete production.

In the following claims and in the preceding description of the invention, except where the context requires otherwise due to express language necessary implication, the word “comprising” is used in an inclusive sense, i.e. the features specified may be associated with further features in various embodiments of the invention. Many variations and/or modifications will be apparent to those skilled in the art and may be made to the parts previously described without departing from the spirit and scope of the present invention.

1. A process of producing a sintered geopolymer article containing a sintered geopolymer composition, wherein the sintered geopolymer composition comprises a sintered geopolymeric matrix, the process comprising the steps of:
forming a geopolymer article from a geopolymer composition, wherein the geopolymer composition comprises an aluminosilicate precursor and an alkali activating agent, and wherein the aluminosilicate precursor content in the geopolymer composition is from 80 to 99.9 wt % of the dry weight of the geopolymer composition, and wherein the alkali activating agent content in the geopolymer composition is less than 12 wt % of the dry weight of the geopolymer composition, and wherein the water content in the geopolymer composition is less than 30 wt % of the total weight of the geopolymer composition, and wherein in the geopolymer article, the aluminosilicate precursor particles are at least partially coated by the alkali activating agent; and
firing the uncured geopolymer article to sinter the geopolymer composition, wherein the alkali activating agent is capable of at least partially activating and dissolving the aluminosilicate precursor particles during at least a portion of the firing step, and wherein the firing of the geopolymer article includes a geopolymer composition sintering stage, wherein the geopolymer composition in the geopolymer article is subjected to a sintering temperature of from 800° C. to 1500° C. during at least a portion of the firing step.

2. A process according to claim 1, wherein during the firing step, the geopolymer article is immediately fired at a temperature of from 800° C. to 1500° C. without preheating of the geopolymer article.

3. A process according to claim 1, wherein the alkali activating agent in the geopolymer composition is used in a solid form, powder form, liquid form or mixtures thereof, and wherein the alkali activating agent content in the geopolymer composition is from 0.1 to 12 wt % of the dry weight of the geopolymer composition.

4. (canceled)

5. A process according to claim 1, wherein the alkali activating agent content in the geopolymer composition is less than 6 wt % of the dry weight of the geopolymer composition.

6. A process according to claim 1, wherein the alkali activating agent content in the geopolymer composition is less than 1 wt % of the dry weight of the geopolymer composition.

7. A process according to claim 1, wherein the alkali activating agent is selected from the group comprising sodium hydroxide, potassium hydroxide, lithium hydroxide, rubidium hydroxide, caesium hydroxide, ammonium hydroxide, calcium hydroxide, sodium silicate, sodium metasilicate, potassium silicate, potassium metasilicate, lithium silicate, sodium carbonate, sodium bicarbonate, potassium carbonate, calcium carbonate, sodium sulfate, calcium sulfate, potassium sulfate, sodium aluminate, borax and mixtures thereof.

8. (canceled)

9. A process according to claim 1, wherein the water content in the geopolymer composition is less than 10 wt % of the total weight of the geopolymer composition.

10. (canceled)

11. A process according to claim 1, wherein the water content in the geopolymer composition is less than 1 wt % of the total weight of the geopolymer composition.

12. (canceled)

13. A process according to claim 1, wherein the aluminosilicate precursor is selected from the group comprising fly ash, blast furnace slag, ground granulated blast furnace slag, metakaolin, aluminum silicate, silica fume, silico-manganese slag, fluid catalytic cracking catalyst residue, coal bottom ash, rice husk ash, palm oil fuel ash, peat-wood ash, sugar cane bagasse ash, waste glass, ceramic wastes, chamotte, waste bricks and pavers, paper/pulp sludge ash, paper/pulp sludge, calcined sludge, municipal solid waste incineration ash, calcined clays, grog, calcined bauxite, sewage sludge, aggregate wash, river and marine silts/sediments, recycled construction and demolition waste, quarry and mine tailings, mineral processing tailings, coal gangue, red mud, aluminum phyllosilicate, clay, shale, slate, feldspars, perlite, alumina, bauxite, kaolin, bentonite, kaolinite, basalt, laterite, volcanic ash, zeolitic tuff, mullite, albite, pyrophyllite, spodumene, beryl, nepheline syenite, almandine, grossular, sillimanite, andalusite, kyanite, pumpellyite, spodumene, augite, lepidolite, illite, celsian, sodalite, stilbite, heulandite, anorthite, pitchstone and mixtures thereof.

14. A process according to claim 1, wherein the aluminosilicate precursor is capable of acting as a binding agent, plasticizing agent, fluxing agent, blowing agent or any combination thereof.

15. (canceled)

16. (canceled)

17. (canceled)

18. A process according to claim 1, wherein the modulus of rupture of the green geopolymer article is greater than 0.1 MPa.

19. A process according to claim 1, wherein the melting point of the alkali activating agent is at a temperature of between 300° C. and 1500° C.

20. A process according to claim 1, wherein the alkali activating agent is capable of acting as a binding agent, fluxing agent, foaming agent, blowing agent or any combination thereof.

21. (canceled)

22. (canceled)

23. (canceled)

24. A process according to claim 1, wherein the geopolymer composition further comprises one or more additive in a total amount of from 0.1 to 19.9 wt % of the dry weight of the geopolymer composition, and wherein the one or more additive is selected from the group comprising filler, catalyst, binding agent, colouring agent, colour oxide, pigment, dye, ceramic additives, water reducing agent, plasticizer, superplasticizer, setting agent, lubricant, surfactant, reinforcing agent, fibers, fire-resistant agent, shrinkage reducing agent, foaming agent, sodium perborate, aluminium oxide, hydrogen peroxide, blowing agent, calcium borate, sodium borate, sintering agent, fluxing agent, iron oxide, cullet powder, silica fume, quartz powder, metallic Fe powder, chloride salt, sodium chloride, calcium chloride, cement dust, lime, limestone, talc, flue gas desulphurisation product, glazing agent, fuel source, coal dust, coal washery waste, ground coal, paper pulp, sewage cake, used oil, waste oil, farming slurries and wastes, biomass fuel, biodegradable municipal solid waste and saw dust.

25. A process according to claim 1, wherein the average particle size of dry components of the geopolymer composition is in the range of 1 μm to 1000 μm.

26. A process according to claim 1, wherein the average particle size of dry components of the geopolymer composition is less than 50 μm.

27. A process according to claim 1, wherein the geopolymer article is formed from the geopolymer composition using pressure forming techniques, non-pressure forming techniques or any combination thereof.

28. A process according to claim 1, wherein the geopolymer composition is subjected to a pressure of from 1 MPa to 80 MPa during pressure forming step.

29. A process according to claim 1, wherein the geopolymer article is fired without applying a waiting period and/or predrying of the geopolymer article.

30. A process according to claim 1, wherein the firing/sintering of the geopolymer article is performed by conventional heating/sintering, microwave heating/sintering, microwave hybrid heating/sintering or any combination thereof.

31. A process according to claim 1, wherein the firing step comprises drying stage, preheating stage, decarbonisation stage, calcination stage, alkali fusion stage, alkali thermal activation stage, dihydroxylation stage, exothermic re-crystallisation stage or any combination thereof, in which the geopolymer composition is subjected to heat treatment at temperatures of between 40° C. to 800° C.

32. A process according to claim 1, wherein the geopolymer composition in the geopolymer article is sintered at a temperature of from 1000° C. to 1300° C. during at least a portion of the firing step.

33. (canceled)

34. A process according to claim 1, wherein the geopolymer article is heated to the sintering temperature at a rate greater than or equal to 600° C./minute during at least a portion of the firing step.

35. A process according to claim 1, wherein the geopolymer article is heated to the sintering temperature at a rate greater than or equal to 200° C./minute during at least a portion of the firing step.

36. A process according to claim 1, wherein the geopolymer article is heated to the sintering temperature at a rate of between 5° C./minute to 600° C./minute during at least a portion of the firing step.

37. (canceled)

38. (canceled)

39. (canceled)

40. A process according to claim 1, wherein the duration of sintering stage is between 1 to 120 minutes.

41. (canceled)

42. (canceled)

43. A process according to claim 1, wherein the duration of sintering stage is less than or equal to 15 minutes.

44. A process according to claim 1, wherein the duration of sintering stage is less than or equal to 5 minutes.

45. A process according to claim 1, wherein the duration of sintering stage is less than or equal to 1 minute.

46. A process according to claim 1, wherein after sintering, the geopolymer article is cooled at a rate greater than or equal to 600° C./minute during at least a portion of the cooling step.

47. A process according to claim 1, wherein after sintering, the geopolymer article is cooled at a rate greater than or equal to 200° C./minute during at least a portion of the cooling step.

48. A process according to claim 1, wherein after sintering, the geopolymer article is cooled at a rate of between 5° C./minute to 600° C./minute during at least a portion of the cooling step.

49. (canceled)

50. (canceled)

51. (canceled)

52. A process according to claim 1, wherein the sintered geopolymer article is a sintered geopolymer aggregate, proppant, brick, paver, wall tile, floor tile, roof tile, benchtop, floating article, cladding, sheeting, precast unit or building element.

53. A process according to claim 1, comprising crushing the sintered geopolymer articles to provide a crushed sintered geopolymer aggregate, and optionally screening and sizing the crushed sintered geopolymer aggregate to a predetermined particle size range.

54. Use of the sintered geopolymer aggregate according to claim 52 in the manufacture of concrete, structural lightweight concrete, high strength lightweight concrete, floating concrete, concrete blocks, precast units, building elements, panels, cladding, composite cladding, lightweight roof tiles, and as a structural fill, floor and roof screed, drainage and filter media and in refractory uses.

55. (canceled)

56. (canceled)

57. Use of the sintered geopolymer aggregate according to claim 53 in the manufacture of concrete, structural lightweight concrete, high strength lightweight concrete, floating concrete, concrete blocks, precast units, building elements, panels, cladding, composite cladding, lightweight roof tiles, and as a structural fill, floor and roof screed, drainage and filter media and in refractory uses.
